(19) United States
(12) Patent Application Publication
(10) Pub. No.: US 2025/0135850 A1
(43) Pub. Date: May 1, 2025

(54) VEHICLE DOOR AND OFF-ROAD VEHICLE

(71) Applicant: KAWASAKI MOTORS, LTD., Hyogo (JP)

(72) Inventors: Akihiro FUKUMOTO, Akashi-shi (JP); Yoshiki TAKAHASHI, Akashi-shi (JP)

(73) Assignee: KAWASAKI MOTORS, LTD., Hyogo (JP)

(21) Appl. No.: 18/497,650

(22) Filed: Oct. 30, 2023

(51) Int. Cl. B60J 5/04; E05B 85/12

(52) U.S. Cl. CPC B60J 5/0413; E05B 85/12

(57) ABSTRACT

A vehicle door 2 includes an inner panel 23 and a grip handle 25 disposed at the inner panel 23. The inner panel 23 has a recess 231, and at least part of the grip handle 25 is positioned inside the recess 231.

### FIELD

The technique disclosed herein relates to a vehicle door and an off-road vehicle.

### BACKGROUND

U.S. Patent Application Publication No. 2016/0280129 discloses a vehicle door. The vehicle door includes an inner panel and a grip handle disposed at the inner panel. The grip handle protrudes to a vehicle interior from a surface of the inner panel.

### SUMMARY

In the vehicle door as described above, the vehicle interior is narrowed due to protrusion of the grip handle to the vehicle interior. For this reason, it is difficult to sufficiently ensure vehicle habitability. Moreover, there is a probability that when a driver drives a vehicle, operability in driving the vehicle by the driver is influenced by contact of an arm of the driver with the grip handle.

The technique disclosed herein has been made in view of such a point, and an object thereof is to increase the vehicle interior in size.

A vehicle door disclosed herein includes an inner panel and a grip handle disposed at the inner panel. The inner panel has a recess, and at least part of the grip handle is positioned inside the recess.

An off-road vehicle disclosed herein includes a vehicle body frame and a door openably attached to the vehicle body frame. The door includes an inner panel and a grip handle disposed at the inner panel. The inner panel has a recess. At least part of the grip handle is positioned inside the recess.

With the vehicle door, the vehicle interior can be increased in size.

In the off-road vehicle, the vehicle interior can be increased in size.

### BRIEF DESCRIPTION OF THE DRAWINGS

FIG. 1 is a left side view of a utility vehicle.

FIG. 2 is a perspective view showing a front left door diagonally from the rear right.

FIG. 3 is a side view showing the front left door from a vehicle-width inside.

FIG. 4 is a sectional view taken along IV-IV line in FIG. 3.

FIG. 5 is a sectional view taken along V-V line in FIG. 3.

FIG. 6 is a side view showing a vehicle interior from the right side when the door is in a fully-closed state.

### DESCRIPTION OF EMBODIMENTS

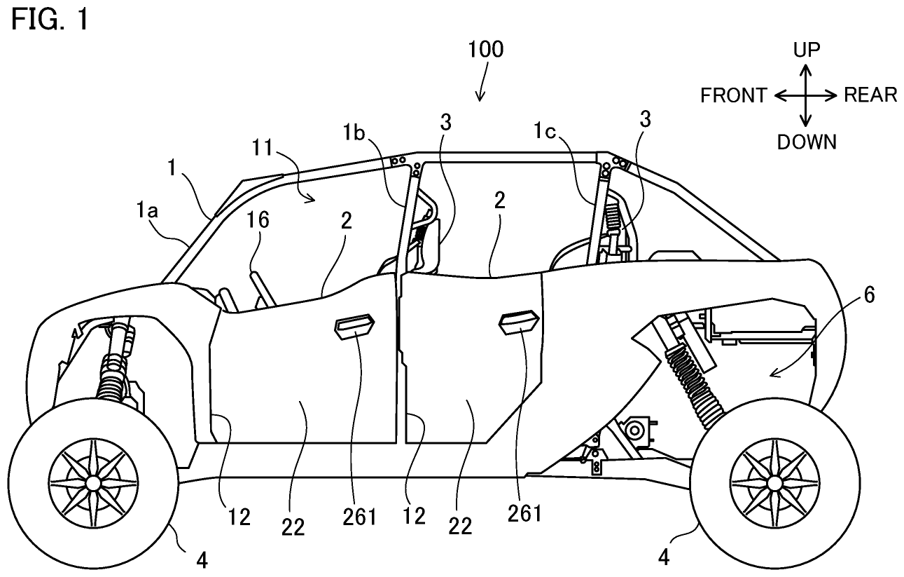

FIG. 1 is a left side view of a utility vehicle 100. The utility vehicle 100 can travel off road. The utility vehicle 100 is one example of an off-road vehicle. Hereinafter, the utility vehicle 100 will also be referred to as a “vehicle 100.”

In the present disclosure, each component of the vehicle 100 will be described using a direction with respect to the vehicle 100. Specifically, a “front” means the front of the vehicle 100 in a vehicle front-rear direction, and a “rear” means the rear of the vehicle 100 in the vehicle front-rear direction. A “left” means the left when facing the front of the vehicle 100, and a “right” means the right when facing the front of the vehicle 100. Note that a right-left direction may also be referred to as a “vehicle width direction.” In the vehicle width direction, a vehicle interior side may be referred to as a “vehicle-width inside,” and a vehicle outer side may be referred to as a “vehicle-width outside.” Each direction with respect to a door 2 is coincident with a corresponding direction with respect to the vehicle 100 when the door 2 is incorporated into the vehicle 100. For example, the front-rear direction of the door 2 is coincident with the front-rear direction of the vehicle 100 when the door 2 is incorporated into the vehicle 100.

The vehicle 100 includes a vehicle body frame 1, the door 2, a seat 3, and a wheel 4. The door 2 is one example of a vehicle door. The door 2 includes a front door and a rear door. The seat 3 includes a front seat and a rear seat. The wheel 4 includes right and left front wheels and right and left rear wheels. That is, the vehicle 100 is a four-wheeled vehicle. An engine room 6 is located in rear of the vehicle body frame 1, specifically in rear of the rear seat. The engine room 6 houses a power unit. The power unit has, for example, an engine, a transmission that changes an output engine speed, a power generator that generates power with the power of the engine, and a battery that stores the power generated by the power generator.

A vehicle interior 11 in which the seat 3 is disposed is defined in the vehicle body frame 1. A side portion of the vehicle body frame 1, i.e., a side portion of the vehicle 100, includes a door opening 12 causing the vehicle interior 11 and the outside of the vehicle to communicate with each other. In this example, both right and left side portions of the vehicle body frame 1 include door openings 12.

The vehicle body frame 1 has a front pillar 1a, a center pillar 1b, and a rear pillar 1c. The front pillar 1a is also called an A-pillar, the center pillar 1b is also called a B-pillar, and the rear pillar 1c is also called a C-pillar.

The front pillar 1a and the center pillar 1b define part of an edge portion of the front door opening 12. Specifically, the front pillar 1a defines the front side of the front door opening 12, and the center pillar 1b defines the rear side of the front door opening 12. The front door 2 is attached to the vehicle body frame 1 so as to open or close the front door opening 12.

The center pillar 1b and the rear pillar 1c define part of an edge portion of the rear door opening 12. Specifically, the center pillar 1b defines the front side of the rear door opening 12, and the rear pillar 1c defines the rear side of the rear door opening 12. The rear door opening 12 is attached to the vehicle body frame 1 so as to open or close the rear door opening 12.

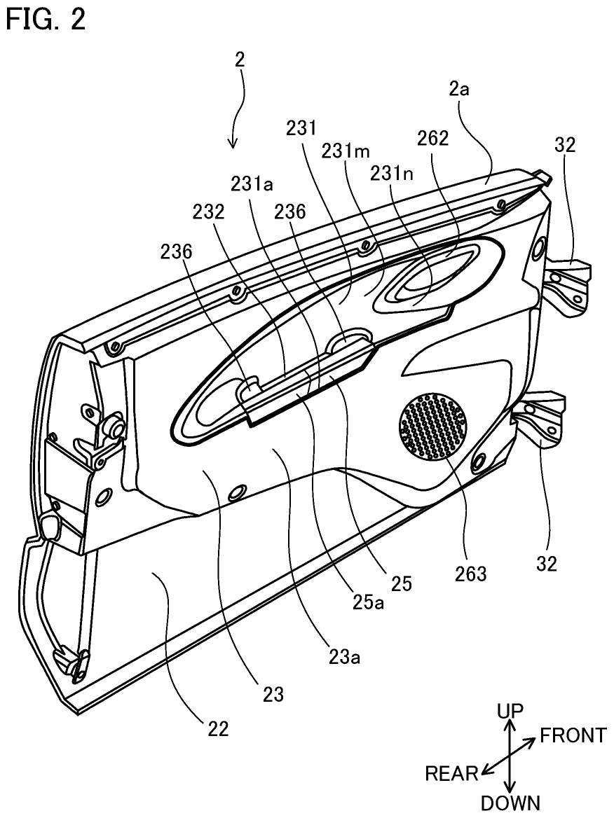

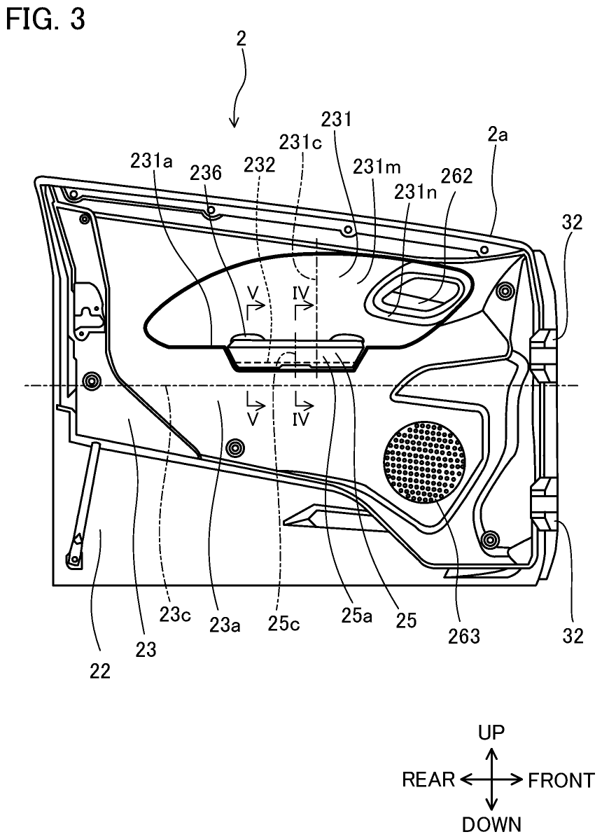

FIG. 2 is a perspective view showing the front left door 2 diagonally from the rear right. FIG. 3 is a side view showing the front left door 2 from the vehicle-width inside.

The door 2 includes a door body 2a and a hinge 32. The hinge 32 is disposed at a front edge portion of the door body 2a. The hinge 32 is attached to the vehicle body frame 1. The door body 2a is supported by the vehicle body frame 1 through the hinge 32. The door body 2a turns in the front-rear direction about a shaft of the hinge 32 to open or close the door opening 12. That is, the hinge 32 turnably supports the door body 2a. In this example, two hinges 32 are disposed. The two hinges 32 are disposed at an interval in an up-down direction at the front edge portion of the door opening 12.

The door body 2a has an outer panel 22 and an inner panel 23. The outer panel 22 is located outside the vehicle, and the inner panel 23 is located in the vehicle interior 11.

The door body 2a is configured such that the outer panel 22 and the inner panel 23 overlap with each other. A power window may be disposed in a space between the outer panel 22 and the inner panel 23. The power window moves up and down to open or close, above the outer panel 22 and the inner panel 23, a space between the vehicle interior 11 and the outside of the vehicle.

The door 2 further includes an outer door handle 261, an inner door handle 262, and a grip handle 25.

The outer door handle 261 is to be rotationally operated by a person outside the vehicle when the person unlocks the door. As shown in FIG. 1, the outer door handle 261 is disposed at the outer panel 22. Specifically, the outer door handle 261 is located at an upper portion of a rear end portion of the outer panel 22.

The inner door handle 262 is to be rotationally operated by an occupant in the vehicle interior 11 when the occupant unlocks the door. As shown in FIGS. 2 and 3, the inner door handle 262 is disposed at the inner panel 23. Specifically, the inner door handle 262 is located at an upper portion of a front end portion of the inner panel 23. The grip handle 25 is to be gripped by the occupant when the occupant opens or closes the door 2. The grip handle 25 is disposed at the inner panel 23. Specifically, the grip handle 25 is located slightly closer to the upper end at the center of the inner panel 23 in the front-rear direction. The grip handle 25 is positioned in rear of the inner door handle 262 and lower than the inner door handle 262.

The inner panel 23 has a recess 231. The recess 231 extends in the front-rear direction. Specifically, the recess 231 is longer in the front-rear direction than in the up-down direction. The length of the recess 231 in the up-down direction is a length in the up-down direction between the uppermost position and lowermost position of the recess 231 as viewed from the vehicle-width inside. The length of the recess 231 in the front-rear direction is a length in the front-rear direction between the frontmost position and rearmost position of the recess 231 as viewed from the vehicle-width inside. In this example, the recess 231 is substantially in an oval shape long in the front-rear direction.

The recess 231 is positioned in an upper portion of the inner panel 23. That is, the entirety of the recess 231 is positioned in the upper portion of the inner panel 23. The upper portion of the inner panel 23 indicates a portion of the inner panel 23 on the upper side with respect to the center 23c in the up-down direction between the uppermost position and lowermost position of the inner panel 23 as viewed from the vehicle-width inside.

At least part of the grip handle 25 is positioned inside the recess 231. The inside of the recess 231 is an inner space of the recess 231 with respect to a surface 23a of the inner panel 23 around the recess 231. In this example, the entirety of the grip handle 25 is positioned inside the recess 231.

An insertion groove 232 into which a finger can be inserted is located between the inner surface of the recess 231 and the grip handle 25. Specifically, part of the inner surface of the recess 231 and the grip handle 25 face each other in the vehicle width direction. The surface of the recess 231 facing the grip handle 25 and the surface of the grip handle 25 facing the recess 231 are separated from each other, and a clearance between the opposing surfaces of the recess 231 and the grip handle 25 defines the insertion groove 232.

The grip handle 25 is positioned in a lower portion of the recess 231. That is, the entirety of the grip handle 25 is positioned in the lower portion of the recess 231. The lower portion of the recess 231 indicates a portion of the recess 231 on the lower side with respect to the center in the up-down direction between the uppermost position and lowermost position of the recess 231 as viewed from the vehicle-width inside.

The grip handle 25 is located along an opening edge portion 231a of the recess 231, and is located along the surface 23a of the inner panel 23 adjacent to the grip handle 25. Specifically, the grip handle 25 is located along the opening edge portion 231a of the lower portion of the recess 231. The opening edge portion 231a is indicated by a thick line in FIGS. 2 and 3. The surface 25a of the grip handle 25 on the vehicle-width inside is located parallel with the surface 23a of the inner panel 23 adjacent to the lower side of the grip handle 25. Thus, the inner surface 25a of the grip handle 25 and the surface 23a of the inner panel 23 define a smooth continuous surface.

The center 25c of the grip handle 25 in the front-rear direction is positioned in rear with respect to the center 231c of the recess 231 in the front-rear direction. The center 25c of the grip handle 25 in the front-rear direction indicates the center of the grip handle 25 in the front-rear direction between the frontmost position and rearmost position of the grip handle 25 as viewed from the vehicle-width inside. The center 231c of the recess 231 in the front-rear direction indicates the center of the recess 231 in the front-rear direction between the frontmost position and rearmost position of the recess 231 as viewed from the vehicle-width inside.

At least part of the inner door handle 262 is positioned inside the recess 231. In this example, the entirety of the inner door handle 262 is positioned inside the recess 231 of the inner panel 23. Specifically, the recess 231 includes a recessed first portion 231m and a second portion 231n recessed in the inner surface of the first portion 231m. The second portion 231n is smaller than the first portion 231m. The second portion 231n is located at a front end portion of the first portion 231m. The inner door handle 262 is disposed at the second portion 231n. The grip handle 25 is disposed at the first portion 231m.

The door 2 further includes a speaker 263. The speaker 263 is disposed at the inner panel 23. The speaker 263 is positioned at a lower front portion of the inner panel 23. The grip handle 25 is positioned in rear of the speaker 263 and higher than the speaker 263.

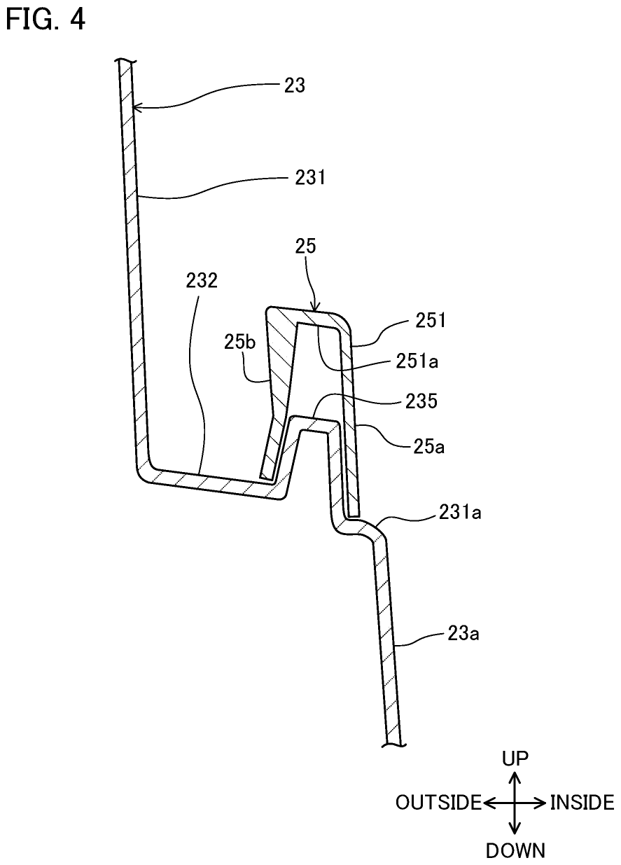

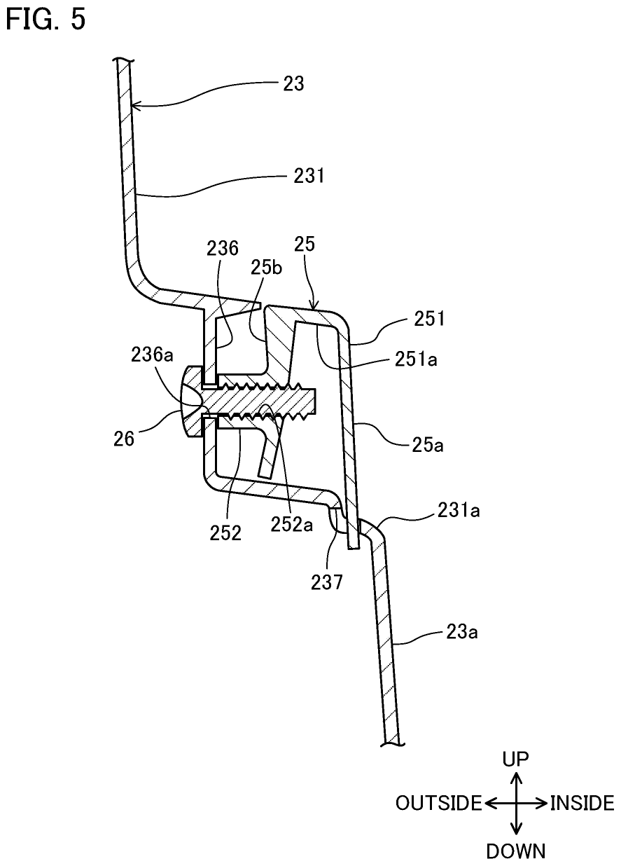

Next, the state of attachment of the grip handle 25 to the inner panel 23 will be described. FIG. 4 is a sectional view taken along IV-IV line in FIG. 3. FIG. 5 is a sectional view taken along V-V line in FIG. 3.

The grip handle 25 has a body portion 251 extending in the front-rear direction and a boss portion 252 located at the body portion 251. In a section perpendicular to the front-rear direction, the body portion 251 has a substantially cup-shaped (or substantially U-shaped) section. The body portion 251 has a groove 251a opened downwardly. The groove 51a extends in the front-rear direction. The body portion 251 has the inner surface 25a on the vehicle-width inside and an outer surface 25b on the vehicle-width outside. The outer surface 25b faces part of the inner surface of the recess 231. The insertion groove 232 is located between the outer surface 25b and part of the inner surface of the recess 231.

The boss portion 252 is located at the outer surface 25b. The boss portion 252 protrudes to the vehicle-width outside. The boss portion 252 has a hole 252a into which a screw 26 can be inserted. The boss portion 252 is located at each of front and rear portions of the body portion 251.

The inner panel 23 has a protrusion 235 protruding upwardly, an attachment portion 236 protruding to the vehicle-width inside, and a slit 237 penetrating the inner panel 23 from the inside to the outside in the vehicle width direction. The protrusion 235 extends in the front-rear direction. The attachment portion 236 is located at each of the front and rear of the protrusion 235. That is, two attachment portions 236 are located apart from each other in the front-rear direction with reference to FIG. 2. The attachment portion 236 has a hole 236a into which the screw 26 can be inserted. The slit 237 is located at a position on the vehicle-width inside with respect to the attachment portion 236.

The protrusion 235 of the inner panel 23 is fitted in the groove 251a of the body portion 251 of the grip handle 25. The tip end of the body portion 251 on the inner surface 25a side is inserted into the slit 237. The boss portion 252 of the grip handle 25 contacts the attachment portion 236 of the inner panel 23. The hole 252a of the boss portion 252 and the hole 236a of the attachment portion 236 communicate with each other. The screw 26 is inserted into the hole 252a of the boss portion 252 and the hole 236a of the attachment portion 236 from the vehicle-width outside, and is screwed into the hole 236a of the attachment portion 236. The boss portion 252 is fixed to the attachment portion 236 with the screw 26. The screw 26 is, for example, a tapping screw, and taps the hole 236a of the attachment portion 236. In this manner, the grip handle 25 is attached to the inner panel 23.

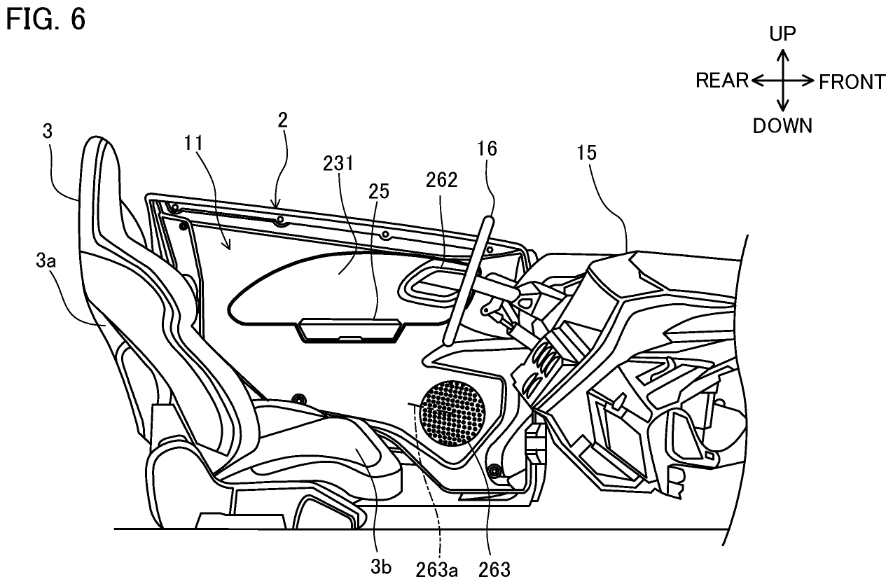

FIG. 6 is a side view showing the vehicle interior 11 from the right side when the door 2 is in a fully-closed state. In the vehicle interior 11, an instrument panel 15 is located in front of a driver seat and a passenger seat, and a steering wheel 16 is located between the instrument panel 15 and the driver seat.

As viewed from the vehicle-width inside, the recess 231 is positioned between the instrument panel 15 and a back portion 3a pf the seat 3. The recess 231 overlaps with the steering wheel 16. The recess 231 is positioned higher than a seating portion 3b of the seat 3. The grip handle 25 is positioned between the steering wheel 16 and the back portion 3a of the seat 3. The grip handle 25 is positioned higher than the seating portion 3b of the seat 3. The inner door handle 262 overlaps with the steering wheel 16. The speaker 263 is positioned between the instrument panel 15 and the seating portion 3b of the seat 3. The speaker 263 is located so as to face the occupant, and specifically, is located such that the center axis 263a of the speaker 263 faces the seat 3. For example, the speaker 263 on the driver seat side is located so as to face the driver seat, and the speaker 263 on the passenger seat side is located so as to face the passenger seat.

According to the above-described door 2, at least part of the grip handle 25 is positioned inside the recess 231 of the inner panel 23. With this configuration, protrusion of the grip handle 25 to the vehicle interior 11 can be reduced, and the vehicle interior 11 can be increased in size. Thus, vehicle habitability can be ensured. When a driver drives the vehicle, contact of an arm of the driver with the grip handle 25 can be reduced, and operability in driving the vehicle by the driver can be improved. In this example, the entirety of the grip handle 25 is positioned inside the recess 231 of the inner panel 23. With this configuration, the grip handle 25 does not protrude to the vehicle interior 11 so that the vehicle interior 11 can be further increased in size.

The recess 231 extends in the front-rear direction. With this configuration, a driver's arm stretched forward when the driver operates the steering wheel 16 can be housed in the recess 231, and interference of the arm by the inner panel 23 can be reduced. Thus, interference of the driver by the inner panel 23 can be reduced, and the operability in driving the vehicle by the driver can be further improved.

The recess 231 is positioned at the upper portion of the inner panel 23. With this configuration, the vehicle interior corresponding to the upper body of the occupant can be increased in size. Thus, interference of an occupant's arm by the inner panel 23 can be further reduced.

The insertion groove 232 is located between the inner surface of the recess 231 and the grip handle 25. With this configuration, the insertion groove 232 can be located in the recess 231, and a dead space in the recess 231 can be effectively utilized. Moreover, the occupant can grip the grip handle 25 with fingers inserted into the insertion groove 232, and operability in opening or closing the door 2 can be improved.

The grip handle 25 is positioned at the lower portion of the recess 231. With this configuration, the occupant can place a hand on the grip handle 25 in the vicinity of a thigh in a seated posture, and can easily grip the grip handle 25.

The grip handle 25 is located along the opening edge portion 231a of the recess 231, and is located along the surface 23a of the inner panel 23 adjacent to the grip handle 25. With this configuration, the grip handle 25 can be located parallel with the surface 23a of the inner panel 23, protrusion of the grip handle 25 to the vehicle interior 11 can be further reduced, and the vehicle interior 11 can be further increased in size.

The center 25c of the grip handle 25 in the front-rear direction is positioned in rear with respect to the center 231c of the recess 231 in the front-rear direction. With this configuration, in a case where the door 2 is openably attached in the front to the vehicle body frame 1, the grip handle 25 can be separated from a portion of the door 2 attached to the vehicle body frame 1. That is, in a case where the door 2 has the hinge 32 in the front and the hinge 32 is attached to the vehicle body frame 1, the grip handle 25 can be separated from the hinge 32. Thus, moment when the occupant opens or closes the door 2 with gripping the grip handle 25 can be increased, and the door 2 can be opened or closed with small force.

In this case, the grip handle 25 is close to the occupant. However, at least part of the grip handle 25 is positioned inside the recess 231 of the inner panel 23, and therefore, protrusion of the grip handle 25 to the vehicle interior 11 can be reduced and interference of the occupant by the grip handle 25 can be reduced.

At least part of the inner door handle 262 is positioned inside the recess 231 of the inner panel 23. With this configuration, protrusion of the inner door handle 262 to the vehicle interior 11 can be reduced, and the vehicle interior 11 can be increased in size. In this example, the entirety of the inner door handle 262 is positioned inside the recess 231 of the inner panel 23. Thus, the inner door handle 262 does not protrude to the vehicle interior 11 so that the vehicle interior 11 can be further increased in size.

According to the above-described vehicle 100, at least part of the grip handle 25 is positioned inside the recess 231 of the inner panel 23. With this configuration, protrusion of the grip handle 25 to the vehicle interior 11 can be reduced, and the vehicle interior 11 can be increased in size.

### OTHER EMBODIMENTS

The embodiment has been described above as an example of the technique disclosed in the present application. However, the technique in the present disclosure is not limited to above, and is also applicable to embodiments to which changes, replacements, additions, omissions, etc. are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

For example, the door 2 includes the front door and the rear door, but may include only the front door. The seat 3 includes the front seat and the rear seat, but may include only the front seat or seats in three or more rows.

The recess 231 extends in the front-rear direction, but may extend in the up-down direction. Specifically, the recess 231 may be longer in the up-down direction than in the front-rear direction.

The entirety of the recess 231 is positioned at the upper portion of the inner panel 23, but at least part of the recess 231 may be positioned at the upper portion of the inner panel 23.

The entirety of the grip handle 25 is positioned inside the recess 231, but part of the grip handle 25 may be positioned outside the recess 231.

The grip handle 25 is positioned at the lower portion of the recess 231, but may be positioned at an upper portion of the recess 231 or be positioned at a front or rear portion of the recess 231.

The entirety of the grip handle 25 is positioned at the lower portion of the recess 231, but at least part of the grip handle 25 may be positioned at the lower portion of the recess 231.

The grip handle 25 is located along the opening edge portion 231a of the recess 231, but may be located on the bottom side of the recess 231. The grip handle 25 is located along the surface 23a of the inner panel 23 adjacent to the grip handle 25, but may be located non-parallel with the surface 23a of the inner panel 23.

The center 25c of the grip handle 25 in the front-rear direction is positioned in rear with respect to the center 231c of the recess 231 in the front-rear direction, but may be positioned in front with respect to the center 231c of the recess 231.

The entirety of the inner door handle 262 is positioned inside the recess 231, but part of the inner door handle 262 may be positioned outside the recess 231.

The grip handle 25 is separated from the inner panel 23, but may be continuously integrated with the inner panel 23. For example, the grip handle 25 may be molded integrally with the inner panel 23.

In the above-described embodiment, the front left door 2 has been described, but the technique disclosed herein is also applicable to the front right door 2, the rear left door 2, and the rear right door 2, needless to say.

The technique disclosed herein is also applicable to a form in which the hinge 32 is disposed on the rear side of the door body 2a.

The technique disclosed herein may be applied to an off-road vehicle other than the utility vehicle 100.

[Aspects]

The above-described embodiment is a specific example of the following aspects. (First Aspect)

The vehicle door 2 includes the inner panel 23 and the grip handle 25 disposed at the inner panel 23. The inner panel 23 has the recess 231, and at least part of the grip handle 25 is positioned inside the recess 231.

According to this configuration, at least part of the grip handle 25 is positioned inside the recess 231 of the inner panel 23. With this configuration, protrusion of the grip handle 25 to the vehicle interior 11 can be reduced, and the vehicle interior 11 can be increased in size.

### (Second Aspect)

In the vehicle door 2 of the first aspect, the entirety of the grip handle 25 is positioned inside the recess 231.

According to this configuration, the entirety of the grip handle 25 is positioned inside the recess 231 of the inner panel 23. With this configuration, the grip handle 25 does not protrude to the vehicle interior 11, and therefore, the vehicle interior 11 can be increased in size.

### (Third Aspect)

In the vehicle door 2 of the first or second aspect, the recess 231 extends in the front-rear direction.

According to this configuration, the recess 231 extends in the front-rear direction. With this configuration, the driver's arm stretched forward when the driver operates the steering wheel 16 can be housed in the recess 231, and interference of the arm by the inner panel 23 can be reduced. Thus, interference of the driver by the inner panel 23 can be reduced, and the operability in driving the vehicle by the driver can be further improved.

### (Fourth Aspect)

In the vehicle door 2 of any one of the first to third aspects, the recess 231 is positioned at the upper portion of the inner panel 23.

According to this configuration, the recess 231 is positioned at the upper portion of the inner panel 23. With this configuration, the vehicle interior 11 corresponding to the upper body of the occupant can be increased in size.

### (Fifth Aspect)

In the vehicle door 2 of any one of the first to fourth aspects, the insertion groove 232 into which a finger can be inserted is located between the inner surface of the recess 231 and the grip handle 25.

According to this configuration, the insertion groove 232 is located between the inner surface of the recess 231 and the grip handle 25. With this configuration, the insertion groove 232 can be located in the recess 231, and the dead space in the recess 231 can be effectively utilized. Moreover, the occupant can grip the grip handle 25 with inserting the fingers into the insertion groove 232, and the operability in opening or closing the door 2 can be improved.

### (Sixth Aspect)

In the vehicle door 2 of any one of the first to fifth aspects, the grip handle 25 is positioned at the lower portion of the recess 231.

According to this configuration, the grip handle 25 is positioned at the lower portion of the recess 231. With this configuration, the occupant can place the hand on the grip handle 25 in the vicinity of the thigh in the seated posture, and can easily grip the grip handle 25.

### (Seventh Aspect)

In the vehicle door 2 of any one of the first to sixth aspects, the grip handle 25 is located along the opening edge portion 231a of the recess 231, and is located along the surface 23a of the inner panel 23 adjacent to the grip handle 25.

According to this configuration, the grip handle 25 is located along the opening edge portion 231a of the recess 231, and is located along the surface 23a of the inner panel 23 adjacent to the grip handle 25. With this configuration, the grip handle 25 can be located parallel with the surface 23a of the inner panel 23, protrusion of the grip handle 25 to the vehicle interior 11 can be further reduced, and the vehicle interior 11 can be further increased in size.

### (Eighth Aspect)

In the vehicle door 2 of any one of the first to seventh aspects, the center 25c of the grip handle 25 in the front-rear direction is positioned in rear with respect to the center 231c of the recess 231 in the front-rear direction.

According to this configuration, the center 25c of the grip handle 25 in the front-rear direction is positioned in rear with respect to the center 231c of the recess 231 in the front-rear direction. With this configuration, in a case where the door 2 is openably attached in the front to the vehicle body frame 1, the grip handle 25 can be separated from the portion of the door 2 attached to the vehicle body frame 1. Thus, the moment when the occupant opens or closes the door 2 with gripping the grip handle 25 can be increased, and the door 2 can be opened or closed with small force.

### (Ninth Aspect)

The vehicle door 2 of any one of the first to eighth aspects further includes the inner door handle 262 disposed at the inner panel 23. At least part of the inner door handle 262 is positioned inside the recess 231.

According to this configuration, at least part of the inner door handle 262 is positioned inside the recess 231 of the inner panel 23. With this configuration, protrusion of the inner door handle 262 to the vehicle interior 11 can be reduced, and the vehicle interior 11 can be increased in size.

### (Tenth Aspect)

The utility vehicle 100 (off-road vehicle) includes the vehicle body frame 1 and the door 2 openably attached to the vehicle body frame 1. The door 2 includes the inner panel 23 and the grip handle 25 disposed at the inner panel 23. The inner panel 23 has the recess 231. At least part of the grip handle 25 is positioned inside the recess 231.

According to this configuration, at least part of the grip handle 25 is positioned inside the recess 231 of the inner panel 23. With this configuration, protrusion of the grip handle 25 to the vehicle interior 11 can be reduced, and the vehicle interior 11 can be increased in size.

1. A vehicle door comprising:
an inner panel; and
a grip handle disposed at the inner panel,
wherein the inner panel has a recess,
an entirety of the grip handle is positioned inside the recess, the inside of the recess being an inner space of the recess with respect to a surface of the inner panel around the recess,
a groove is located between an inner surface of the recess and the grip handle,
the inner surface of the recess and a surface of the grip handle face each other in the vehicle width direction and are separated from each other,
a clearance between the facing surfaces of the recess and the grip handle defines the groove, and
the grip handle is located at an opening edge portion of the recess between the surface of the inner panel and the groove, and extends along the opening edge portion of the recess.

2. (canceled)

3. The vehicle door of claim 1, wherein the recess extends in a front-rear direction.

4. The vehicle door of claim 1, wherein
the recess is positioned at an upper portion of the inner panel.

5. The vehicle door of claim 1, wherein
an insertion groove is located between the inner surface of the recess and the grip handle.

6. The vehicle door of claim 1, wherein
the grip handle is positioned at a lower portion of the recess.

7. The vehicle door of claim 1, wherein
the grip handle extends along an adjacent surface of the inner panel.

8. The vehicle door of claim 1, wherein
a center of the grip handle in a front-rear direction is positioned rearward of a center of the recess in the front-rear direction.

9. The vehicle door of claim 1, further comprising:
an inner door handle disposed at the inner panel,
wherein at least part of the inner door handle is positioned inside the recess.

10. An off-road vehicle comprising:
a vehicle body frame; and
a door openably attached to the vehicle body frame,
wherein the door includes:
an inner panel, and
a grip handle disposed at the inner panel,
the inner panel has a recess, and
an entirety of the grip handle is positioned inside the recess, wherein a groove is located between an inner surface of the recess and the grip handle,
the inner surface of the recess and a surface of the grip handle face each other in the vehicle width direction and are separated from each other,
a clearance between the facing surfaces of the recess and the grip handle defines the groove, and
the grip handle is located at an opening edge portion of the recess between the surface of the inner panel and the groove, and extends along the opening edge portion of the recess.

11. A vehicle door comprising:
an inner panel; and
a grip handle disposed at the inner panel,
wherein the inner panel has a recess,
an entirety of the grip handle is positioned inside the recess, the inside of the recess being an inner space of the recess with respect to a surface of the inner panel around the recess,
a groove is located between an inner surface of the recess and the grip handle,
the grip handle is located at an opening edge portion of the recess between the surface of the inner panel and the groove, and extends along the opening edge portion of the recess,
the inner panel has a protrusion protruding upwardly and extending in the front-rear direction along the opening edge portion of the recess, and
the grip handle includes a body portion having an inverted U-shape for fitting over the protrusion of the inner panel for locating the grip handle relative to the inner panel.

12. An off-road vehicle comprising:
a vehicle body frame; and
a door openably attached to the vehicle body frame,
wherein the door includes:
an inner panel, and
a grip handle disposed at the inner panel,
the inner panel has a recess,
an entirety of the grip handle is positioned inside the recess, the inside of the recess being an inner space of the recess with respect to a surface of the inner panel around the recess,
a groove is located between an inner surface of the recess and the grip handle,
the grip handle is located at an opening edge portion of the recess between the surface of the inner panel and the groove, and extends along the opening edge portion of the recess,
the inner panel has a protrusion protruding upwardly and extending in the front-rear direction along the opening edge portion of the recess, and
the grip handle includes a body portion having an inverted U-shape for fitting over the protrusion of the inner panel for locating the grip handle relative to the inner panel.
